(19) United States
(12) Patent Application Publication
(10) Pub. No.: US 2004/0268120 A1
(43) Pub. Date: Dec. 30, 2004

(54) System and method for public key infrastructure based software licensing

(75) Inventors: Ajay Mirtal, Foster City, CA (US); Chandra Tekwani, San Jose, CA (US)

Correspondence Address: MERCHANT & GOULD PC, P.O. BOX 2903, MINNEAPOLIS, MN, 55402-0903, US

(73) Assignee: Nokia, Inc., Irving, TX

(21) Appl. No.: 10/609,344

(22) Filed: Jun. 26, 2003

(51) Int. Cl. H04L 9/32; G06F 11/30

(52) U.S. Cl. 713/156; 713/202

(57) ABSTRACT

A system and method is directed to electronic licensing of software using a public key infrastructure (PKI). A Licensing Authority is employed as a trusted entity to issue and manage licenses to an end-user, in a substantially similar manner as a certification authority in the PKI might issue and manage a public-key certificate. The Licensing Authority may request information including a credit card number from the end-user seeking to purchase the software. The Licensing Authority employs the provided information to authenticate the end-user and issue a digitally signed license to the end-user. The end-user employs the license to enable access to the requested software. In one embodiment, the license format is substantially similar to a public key certificate's format. The license may include a period of validity after which the license is invalid. Moreover, in one embodiment, the license may be renewed to enable continued access of the associated software.

### FIELD OF THE INVENTION

The present invention relates generally to software licensing, and in particular to a method and system for electronic software licensing employing a public key infrastructure.

### BACKGROUND OF THE INVENTION

Today's software vendors are straining to maintain revenue growth, reduce operational costs, and maintain or improve customer satisfaction and retention. While many software vendors continue to evolve their software products, their customers have grown dissatisfied with the archaic methods employed for purchasing, receiving, installing, and managing the software products.

In spite of the innovation promised by the Internet and other technologies, many software vendors are still shipping their software in boxes, on CDs, and the like. Moreover, many of these software vendors are still providing software licenses to their software in the boxes, on CDs, and the like. However, some software companies have taken advantage of the increased popularity of the Internet to enable purchases of their software products over the Internet. Many of these software companies however, have selected to implement proprietary licensing schemes. This sometimes results in confusion and inconsistent use by the customer, and thus additional customer dissatisfaction. Such varied licensing schemes may also result in additional costs to the software company. Therefore, it is with respect to these considerations, and others, that the present invention has been made.

### SUMMARY OF THE INVENTION

The present invention is directed to addressing the above-mentioned shortcomings, disadvantages and problems, and will be understood by reading and studying the following specification. The present invention provides a system and method directed to electronic licensing of software using a public key infrastructure.

In one aspect of the invention, a method is directed to licensing software. An electronic request for a license is received that includes information associated with an end-user and an identifier associated with a software product. The information is employed to authenticate the end-user. When the end-user is authentic, a Licensing Authority is employed to digitally sign the license that enables access to the software product.

In another aspect of the invention, a method is directed to using a public key infrastructure for licensing software. A request for a license to access a software product is forwarded to a Licensing Authority. The request comprises information associated with an end-user. When the Licensing Authority determines the end-user is authentic, a digitally signed license is received from the Licensing Authority. The digitally signed license is then employed to enable access to the software product.

In still another aspect of the invention, a system is directed to electronic licensing of a software product. The system includes a client computer and a Licensing Authority. The client computer is configured to provide an electronic request for a license. The Licensing Authority receives the electronic request for the license that includes information associated with an end-user and an identifier associated with the software product. The information is employed by the Licensing Authority to authenticate the end-user. If the end-user is authentic, the Licensing Authority digitally signs the license, and notifies the client computer where to obtain the digitally signed license so that the digitally signed license may enable access to the software product.

In yet another aspect of the invention, a system is directed to electronically licensing a software product. The system includes a means for receiving an electronic request for a license that includes information associated with an end-user and an identifier associated with a software product. The system further includes a means for employing the information to authenticate the end-user. Moreover, the system also includes a means for employing a Licensing Authority to digitally sign the license when the end-user is authentic. The digitally signed license is substantially similar to a Public-Key Certificate in an Internet Public Key Infrastructure (PKI), and enables access to the software product.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description of the Preferred Embodiment, which is to be read in association with the accompanying drawings, wherein:

FIG. 1 illustrates an exemplary environment in which a Licensing Authority and Licensing Repository may operate for managing software licenses;

FIG. 2 illustrates components of an exemplary server computer environment in which the invention may be practiced;

FIG. 3 illustrates components of an exemplary client computer environment in which the invention may be practiced;

FIG. 4 illustrates components of one embodiment of a software license;

FIG. 5 illustrates a flow chart for one embodiment of a process for requesting a software license; and

FIG. 6 illustrates a flow chart for one embodiment of a process for employing a software license to enable execution of software, in accordance with the present invention.

### DETAILED DESCRIPTION OF THE PREFERRED EMBODIMENT

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely. software embodiment or an embodiment combining software and hardware aspects. The following detailed description is, therefore, not to be taken in a limiting sense.

The term “coupled,” and “connected,” include a direct connection between the things that are connected, or an indirect connection through one or more either passive or active intermediary devices or components.

The terms “comprising,” “including,” “containing,” “having,” and “characterized by,” include an open-ended or inclusive transitional construct and does not exclude additional, unrecited elements, or method steps. For example, a combination that comprises A and B elements, also reads on a combination of A, B, and C elements.

The meaning of “a,” “an,” and “the” include plural references. The meaning of “in” includes “in” and “on.” Additionally, a reference to the singular includes a reference to the plural unless otherwise stated or is inconsistent with the disclosure herein.

Briefly stated, the present invention is directed towards a system and method for electronic licensing of a software product using a Public Key Infrastructure (PKI). A Licensing Authority is employed as a trusted entity to issue and manage a license to an end-user, in a substantially similar manner as a Certification Authority in the PKI might issue and manage a public-key certificate. That is, the Licensing Authority may request information about the end-user seeking to access the software product. The Licensing Authority employs the provided information to authenticate the end-user and issue a digitally signed license to the authenticated end-user. The end-user employs the license to enable access to the requested software product. In one embodiment, the license format is substantially similar to an Internet X.509 Public Key certificate format. The license may be associated with a single software product or multiple software products. The license may include a period of validity after which the license is invalid and may need to be renewed to continue access to the software product. In one embodiment, the license includes an extension field that enables access to additional information regarding the software product for which the license is valid, including, but not limited to access rights and permissions associated with the software product, and the like.

Illustrative Operating Environment

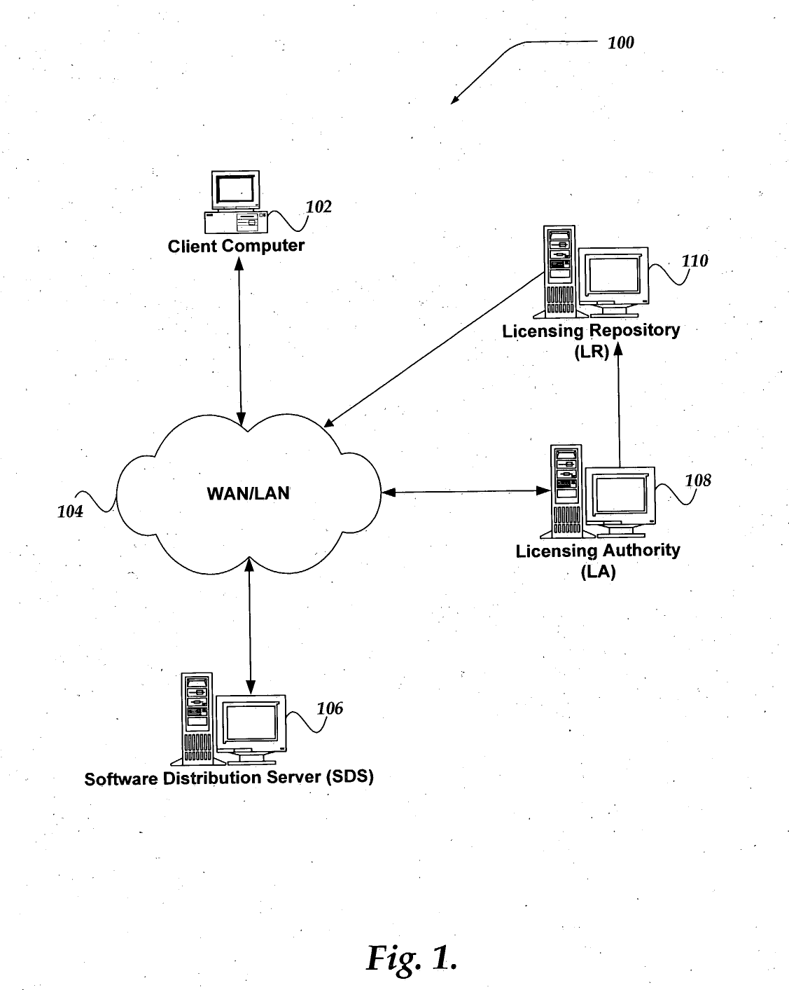

FIG. 1 illustrates an exemplary environment in which a Licensing Authority and Licensing Repository may operate for managing an electronic license to software. Not all of the components may be required to practice the invention, and variations in the arrangement and type of the components may be made without departing from the spirit or scope of the invention.

As shown in the figure, system 100 includes client computer 102, wide area network (WAN)/local area network (LAN), Software Distribution Server (SDS) 106, Licensing Authority (LA) 108, and License Repository (LR) 110. WAN/LAN 104 is in communication with client computer 102, SDS 106, LA 108, and LR 110.

Client computer 102 may be any device capable of sending a request for and receiving of a license for software over a network, such as WAN/LAN 104. The set of such devices may include devices that typically connect using a wired communications medium such as personal computers, multiprocessor systems, microprocessor-based or programmable consumer electronics, network PCs, and the like. The set of such devices may also include devices that typically connect using a wireless communications medium such as cell phones, smart phones, pagers, walkie talkies, radio frequency (RF) devices, infrared (IR) devices, CBs, integrated devices combining one or more of the preceding devices, and the like. Alternatively, client computer 102 may be any device that is capable of connecting using a wired or wireless communication medium such as a PDA, POCKET PC, wearable computer, or other device mentioned above that is equipped to use a wired and/or wireless communication medium.

WAN/LAN 104 couples client computer 102 with LA 108, and SDS 106. WAN/LAN 104 is enabled to employ any form of computer readable media for communicating information from one electronic device to another. In addition, WAN/LAN 104 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, WAN/LAN 104 includes any communication method by which information may travel between client computer 102, SDS 106, LA 108, and LR 110.

SDS 106 may include virtually any computing device capable of receiving a request for software, and providing software in response to a validated request. SDS 106 maybe deployed as a website, a File Transfer Protocol (FTP) site, a code repository site, software product database site, and the like.

SDS 106 may receive a request for software from client computer 102. In one embodiment, the request includes a license. SDS 106 may request and receive information from LR 110 to determine whether the provided license is valid for the requested software. SDS 106 may employ information associated with the valid license to encrypt the software for delivery to client computer 102. For example, SDS 106 may employ a public encryption key associated with the license to encrypt the software such that an unauthorized user is inhibited from accessing the software.

SDS 106 may also be configured to determine whether a license has been tampered with, or otherwise compromised. If SDS 106 determines that the license has been tampered with, or otherwise compromised, it may send a request to LA 108 to have the license revoked.

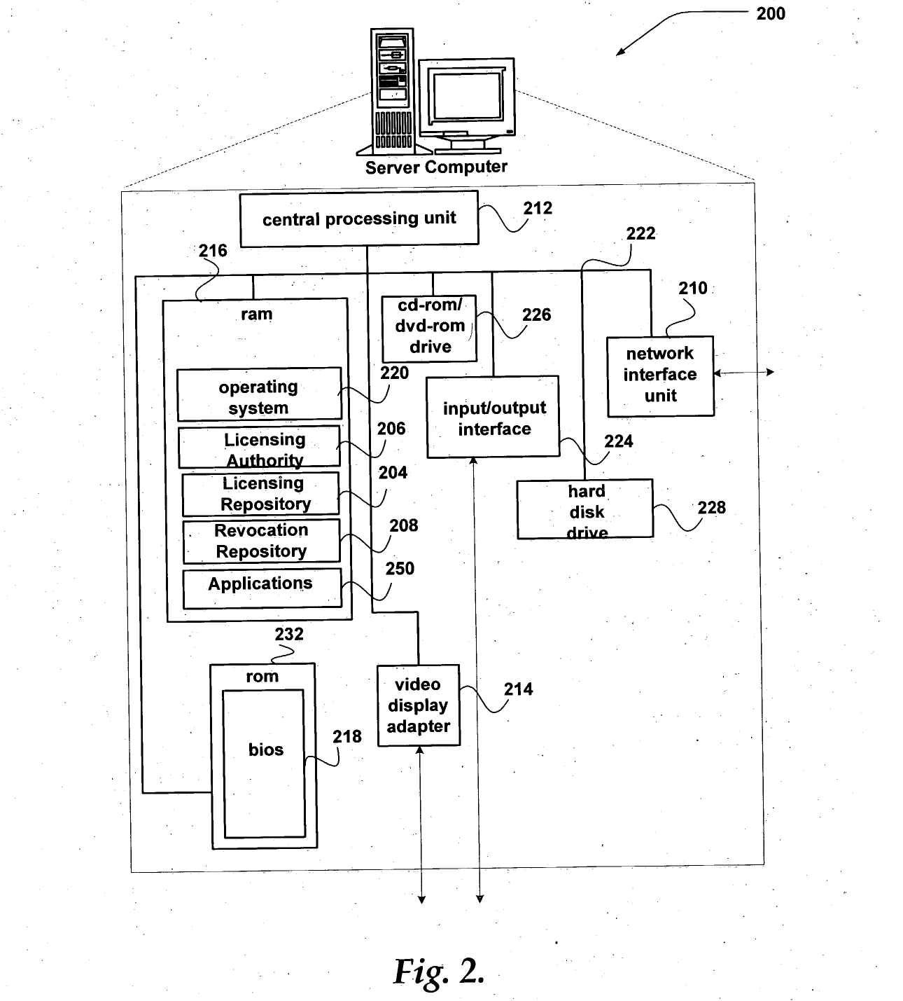

Devices that may operate as SDS 106 include, but are not limited to, personal computers desktop computers, multiprocessor systems, microprocessor-based or programmable consumer electronics, network PCs, servers, and the like. FIG. 2. illustrates one embodiment of SDS 106 as a server computer.

LA 108 may include virtually any computing device configured to operate as a trusted Licensing Authority, in a substantially similar manner to a Certification Authority (CA) in an Internet Public Key Infrastructure (PKI), X.509 PKI, and the like. That is, LA 108 is configured to operate as a trusted third-party entity to issue and manage licenses to an end-user of client computer 102, and the like, in a manner substantially similar to how the CA might issue and manage a public-key certificate. For example, a role of LA 108 is to provide a level of assurance that the end-user granted the license is, in fact, who he or she claims to be, substantially like a role of a CA.

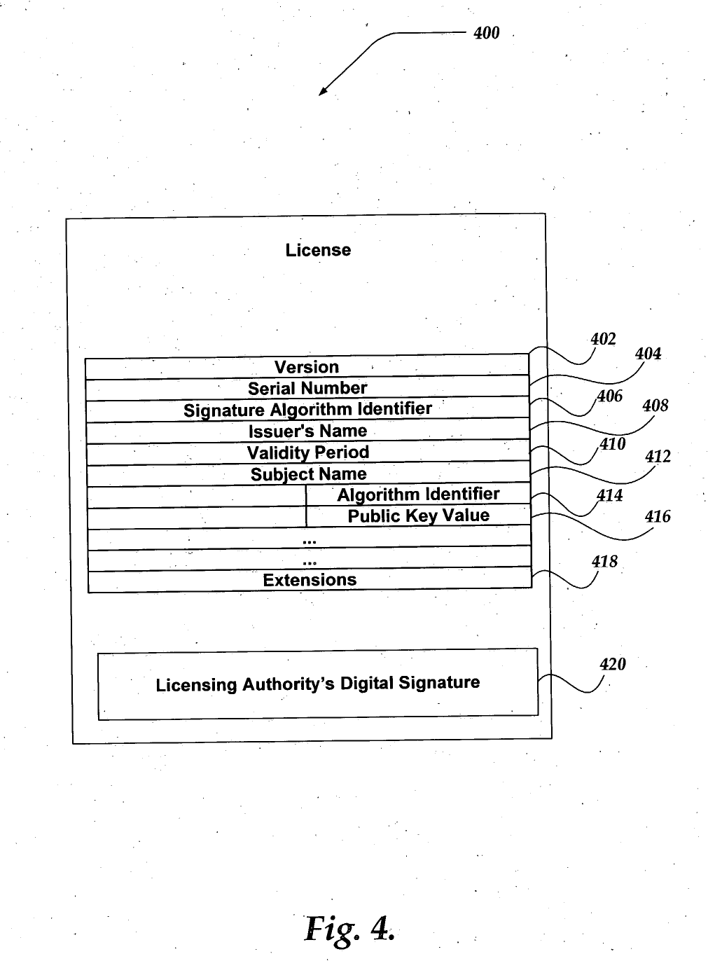

One embodiment of a license is described in more detail below in conjunction with FIG. 4. Briefly, however, a license is a data structure that is directed at enabling an end-user to access selected software. The license is directed towards binding selected rights to the software together with an identity of an end-user. The binding is asserted in part when LA 108 digitally signs the license. LA 108 may select to make the assertion based in part upon a technical mechanism, such as proof of possession of the software through a challenge-response protocol. In another embodiment, LA 108 may select to make the assertion based in part upon a variety of levels of authentication of the end-user.

LA 108 may employ an out-of-band process to determine a desired level of authentication the end-user. LA 108 may request information from client computer 102 in authenticating the end-user, including but not limited to, a legal name, address, email address, telephone number, identification of a software product to be purchased, credit information, credit card information, employment information, driver's license, and the like. LA 108 may also request payment for the software, through for example, authorization to use the credit card information. LA 108 may request such information by employing a web based form, an email thread, and the like.

LA 108 may be configured to employ an out-of-band source to determine the authenticity of the provided information. The out-of-band source may include, but is not limited to, an identified employer, a motor vehicle department, a credit card company, a financial institution, an educational institution, a government institution, and the like. If the out-of-band source indicates that the provided information is valid, LA 108 may assume that the end-user is authentic. LA 108 is configured then to digitally sign and issue the license to the end-user for the requested software.

LA 108 may be configured to issue the license to be valid for virtually any period of time. For example, LA 108 may issue the license for one year, such that the end-user must request a renewal of the license to continue use of the software. LA 108 may also issue the license for a limited user of the software. For example, the license may be issued to enable a single-use of the software, a trial period use of the software, a restricted feature use of the software, a restricted computing system configuration, and the like.

LA 108 may be further configured to provide a notification to client computer 102 indicating how to obtain the license. The notification may include an email message, a webpage response, and the like. In one embodiment, the notification is an email message that includes a password and URL to access the license. LA 108 may further provide a copy of the license to LR 110.

LA 108 may, also provide LR 110 with information about a revoked license. LA 108 may revoke a license based on a variety of conditions, including, but not limited to, information obtained from the employer, credit card company, government institution, financial institution, educational institution, software vendor, and the like. LA 108 may also receive information from SDS 106, client computer 102, and the like, indicating that the license may have been tampered with, or otherwise compromised, and needs to be revoked. LA 108 may provide information about a revoked license by issuing and managing a time-stamped list of revoked licenses, called a License Revocation List (LRL), which has been digitally signed by LA 108.

LR 110 may include a computing system or collection of distributed computing systems that is configured to store a license, a LRL, and the like. LR 110 may further operate as a mechanism for distributing the license, LRL, and the like to client computer 102, SDS 106, and the like. In one embodiment, LR 110 operates in a manner substantially similar to a certificate/certificate revocation list (CRL) repository in an Internet X.509 Public Key Infrastructure.

LR 110 may be configured to receive the license, and LRL from LA 108, and store them in a database, on a Lightweight Directory Access Protocol (LDAP) server, an X.500 directory server, Active Directory server, and the like.

Although FIG. 1 illustrates LA 108 and LR 110 as separate computing devices, the present invention, is not so limited. For example, LA 108 and LR 110 may be deployed within a single computing system, location, and the like, without departing from the scope or spirit of the present invention. Moreover, LA 108 maybe a component, of SDS 106. In one embodiment, the same software vendor manages SDS 106, LA 108, and LR 110.

FIG. 2 shows an exemplary server computer 200 that may be included in a system implementing the invention, according to one embodiment of the invention. Server computer 260 may operate as personal computer, desktop computer, multiprocessor system, microprocessor-based or programmable consumer electronics, network PC, server, and the like. Server computer 200 may be configured to operate as SDS 106, LA 108, and LR 110 of FIG. 1.

Server computer 200 may include many more components than those shown. The components shown, however, are sufficient to disclose an illustrative embodiment for practicing the invention.

Server computer 200 includes processing unit 212, video display adapter 214, and a mass memory, all in communication with each other via bus 222. The mass memory generally includes RAM 216, ROM 232, and one or more permanent mass storage devices, such as hard disk drive 228, tape drive, optical drive, and/or floppy disk drive. The mass memory stores operating system 220 for controlling the operation of server computer 200. It will be appreciated that this component may comprise a general-purpose server operating system including but not limited to UNIX, LINUX™, one produced by Microsoft Corporation of Redmond, Washington, and the like. Basic input/output system (“BIOS”) 218 is also provided for controlling the low-level operation of server computer 200. As illustrated in FIG. 2, server computer 200 also can communicate with the Internet, or some other communications network via network interface unit 210, which is constructed for use with various communication protocols including. the TCP/IP protocol. Network interface unit 210 is sometimes known as a transceiver or transceiving device.

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

In one embodiment, the mass memory stores program code and data for performing the functions of server computer 200. One or more applications 250 are loaded into mass memory and run on operating system 220. For example, Licensing Authority 206, and License Repository 204, and Revocation Repository 208, may be loaded and run on operating system 220.

Server computer 200 may also include an SMTP handler application for transmitting and receiving email for a message delivery system, an HTTP handler application for receiving and handing HTTP requests, and an HTTPS handler application for handling secure connections. The HTTPS handler application may initiate communication with an external application in a secure fashion.

Server computer 200 also includes input/output interface 224 for communicating with external devices, such as a mouse, keyboard, scanner, or other input devices not shown in FIG. 2. Likewise, server computer 200 may further include additional mass storage facilities such as CD-ROM/DVD-ROM drive 226 and hard disk drive 228. Hard disk drive 2328 is utilized by server computer 200 to store, among other things, application programs, License Repository 204, Revocation Repository 208, Licensing Authority 206, access rights databases, software product databases, and the like.

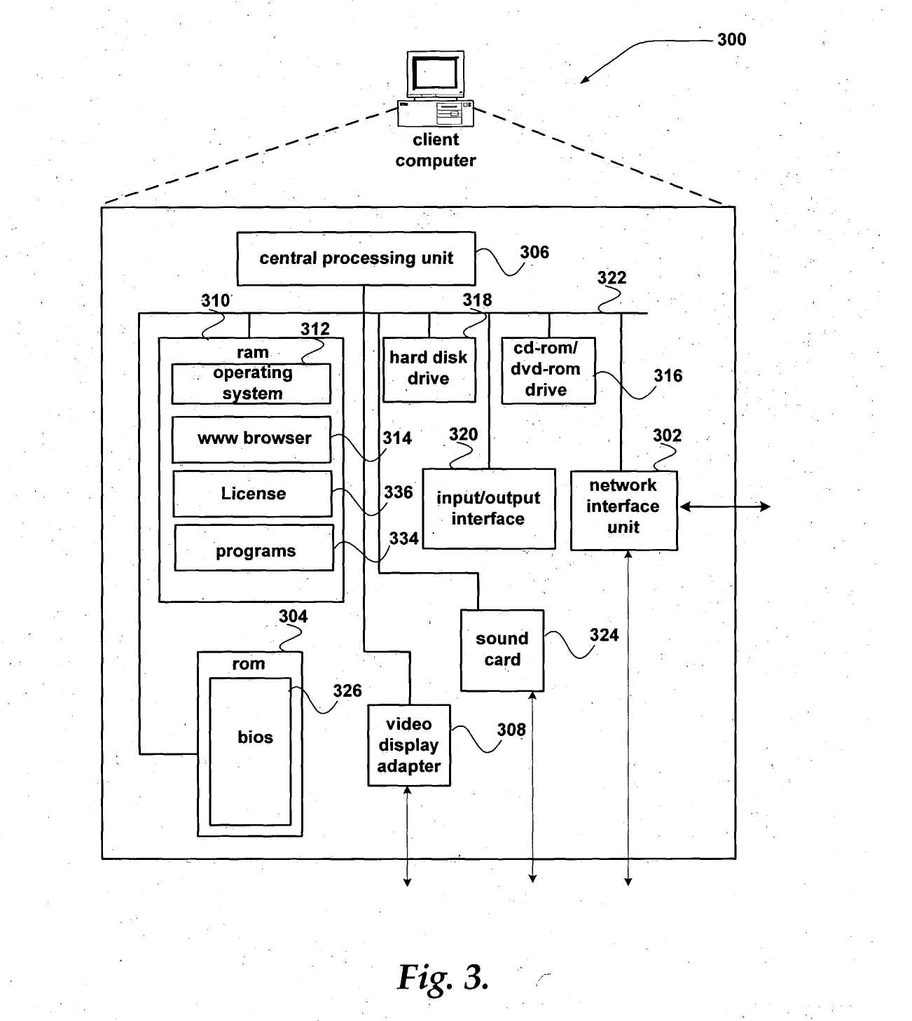

FIG. 3 depicts several components of client computer 300. Client computer 300 may include many more components than those shown in FIG. 3. However, it is not necessary that those generally conventional components be shown in order to disclose an illustrative embodiment for practicing the present invention. As shown in FIG. 3, client computer 300 includes network interface unit 302 for connecting to a LAN or WAN, or for connecting remotely to a LAN or WAN. Network interface unit 302 includes the necessary circuitry for such a connection, and is also constructed for use with various communication protocols including the TCP/IP protocol, the particular network configuration of the LAN or WAN it is connecting to, and a particular type of coupling medium. Network interface unit 302 may also be capable of connecting to the Internet through a point-to-point protocol (“PPP”) connection or a serial line Internet protocol (“SLIP”) connection.

Client computer 300 also includes BIOS 326, processing unit 306, video display adapter 308, and memory. The memory generally includes RAM 310, ROM 304, and a permanent mass storage device, such as a disk drive. The memory stores operating system 312 and programs 334 for controlling the operation of client computer 300. The memory also includes WWW browser 314, such as Netscape's NAVIGATOR® or Microsoft's INTERNET EXPLORER® browsers, for accessing the WWW. Memory further includes license 336 for accessing and enabling software, such as programs 334. It will be appreciated that these components may be stored on a computer-readable. medium and loaded into memory of client computer 300 using a drive mechanism associated with the computer-readable medium, such as a floppy disk drive (not shown), optical drive 316, such as a CD-ROM/DVD-ROM drive, and/or hard disk drive 318. Input/output interface 320 may also be provided for receiving input from a mouse, keyboard, or other input device. The memory, network interface unit 302, video display adapter 308, and input/output interface 320 are all connected to processing unit 306 via bus 322. Other peripherals may also be connected to processing unit 306 in a similar manner. A client and devices like a client are other examples of a network device. Any other device that is capable of connecting to a network may also be included as an example of a network device.

FIG. 4 illustrates components of one embodiment of a license for use in enabling access to software within a PKI. License 400 may include many more components than those shown. The components shown, however, are sufficient to disclose an illustrative embodiment for practicing the invention.

License 400 represents a data structure that is directed to strongly associating (i.e., binding) a right to use of a software product to a particular end-user. The association may be in the form of a look-up list of a software product included within the license, such as through an extension, serial number, and the like.

A trusted Licensing Authority, such as LA 108 of FIG. 1, may issue the license. The trusted Licensing Authority digitally signs license 400, thereby, serving to provide authentication for the associated end-user. The digital signature is also designed to deter tampering of license 400, and to make license 400 usable only by the targeted end-user.

License 400 may be viewed as a cornerstone of licensing software employing a PKI. In one embodiment, license 400 is configured substantially similar to an X.509 Public Key Infrastructure Certificate format, as described in the Internet Engineering Task Force's Request for Comments (RFC) 2459, and which is hereby incorporated by reference.

As shown in FIG. 4, license 400 includes version 402, serial number 404, signature algorithm identifier 406, issuer's name 408, validity period 410, subject name 412, algorithm identifier 414, public key value 416, extensions 418, and Licensing Authority's digital signature 420.

Version 402 includes an indicator of the version of the license format. Versions may be substantially similar to the versions for public-key certificates. Serial number 404 includes a unique identifying number, text, and the like, for each license. In one embodiment, serial number 404 represents a value that is associated with the software to which the end-user is granted access.

Issuer's name 406 includes information of the issuing Licensing Authority. In one embodiment, issuer's name 406 is an X.500 name.

Validity period 410 includes a start and expiration date and time of license 400. That is, validity period 410 may indicate when license 400 is no longer valid, such that it should no longer be honored.

Subject name 412 may include a name of the holder of a private key associated with the license. Subject name 412 may represent the name of the end-user, computer system, a company, and the like. In one embodiment, subject name 412 is an X.500 name.

Algorithm identifier 414 includes an identifier of an algorithm with which the public key is created. Such algorithms may include, but are not limited to, a Rivest-Shamir-Adleman (RSA) algorithm, Digital Signature Standard (DSS) algorithm, Diffie-Hellman algorithm, and the like. Public key value 416 includes the public key associated with the end-user. The public key may be generated, together with its private key by software on client computer 102 of FIG. 1. The public key may be provided to the Licensing Authority during an exchange of communications as part the license request. The associated private key may be stored on the end-user's computing system, another computing system, and the like.

Extensions 418 include one or more data fields that may be employed to extend the license. Extensions 418 may include an identifier, data string, text, and the like. In one embodiment, extensions 418 provide information about the software for which license 400 is valid. Extensions 418 may include a Universal Resource Locator (URL) to a network site for additional restrictions, rights, and the like, associated with license 400. Extensions 418 may also include a hash that enables access to the software product, a software product identifier, information regarding access rights to the software product, and the like.

Extensions 418 may include multiple data fields, representing a license to a single software product. Extensions 418 may also be employed to enable a single license for use with multiple software products.

License 400 further includes Licensing Authority's digital signature 420, which may be employed to indicate the level of trust associated with subject name 412.

Generalized Operation

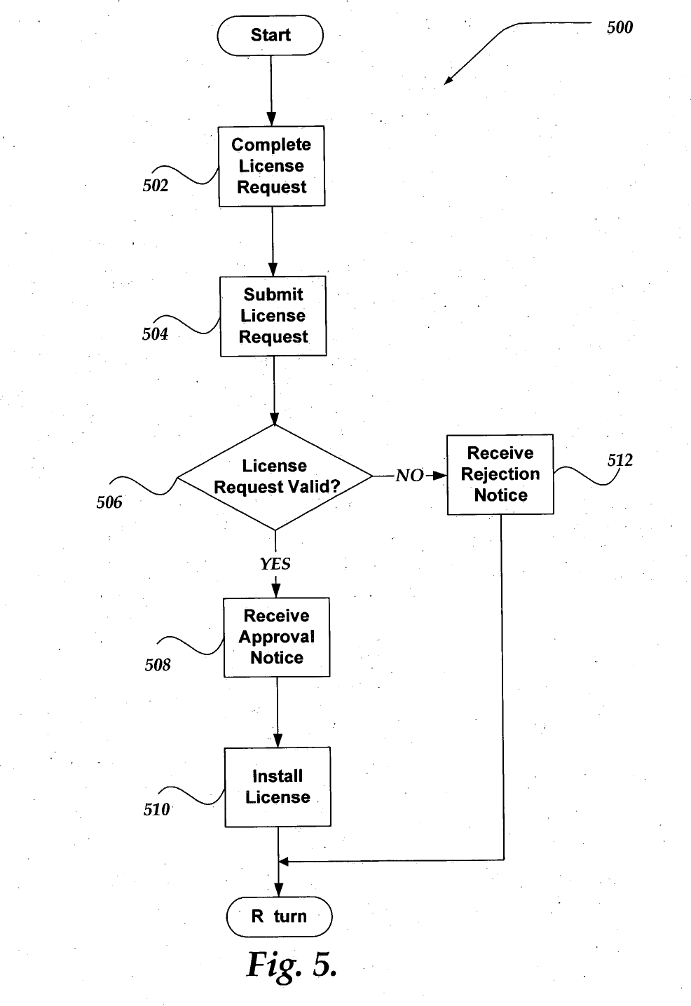

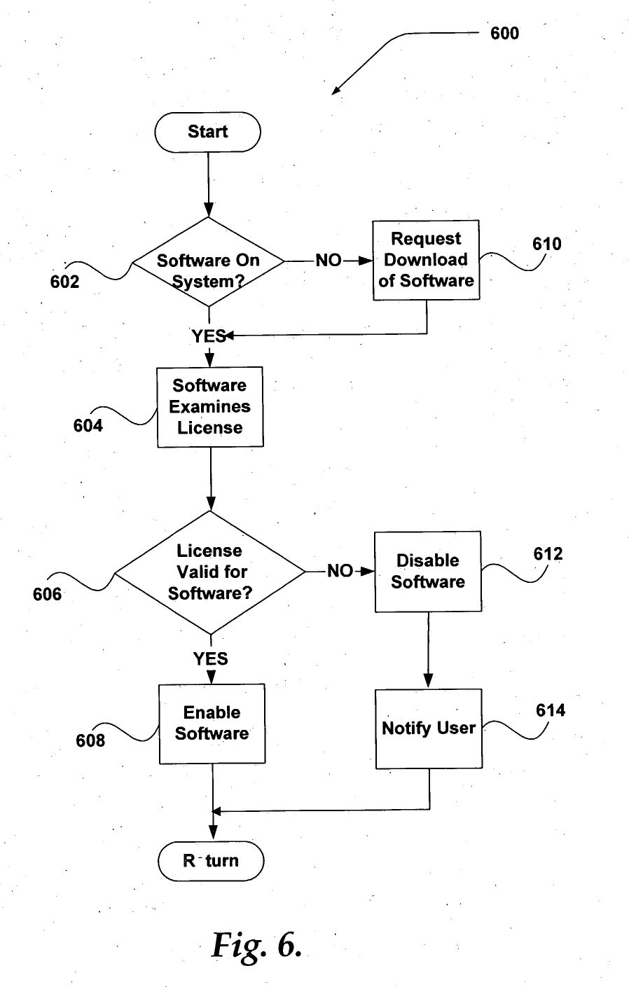

The operation of certain aspects of the present invention will now be described with respect to FIGS. 5-6. FIG. 5 illustrates a flow chart for one embodiment of a process for requesting a software license. Process 500 may operate for example, in client computer 102 of FIG. 2. Process 500 may be employed when an end-user seeks a new license to enable access to a software product. Process 500 may also be employed when an existing license has expired, been revoked, and the like, and the end-user seeks to renew the license.

Process 500 begins, after a start block, at block 502, when an end-user determines that they desire to obtain a license to gain access to software. The end-user may employ a browser, email, another software program, and the like, to communicate with the Licensing Authority to request the license. In one embodiment, the end-user accesses a website that includes a license request web-based form. In another embodiment, the end-user communicates with the Licensing Authority employing a secure, encrypted, communication link. The end-user completes the license request, providing information including, but not limited to a name, address, phone number, identification of the software product, credit information, credit card information, employment information, driver's license information, and the like. Such requested information may be directed to uniquely identifying the end-user and software product. The information may include a request for a single software product, or for multiple software products. The information may also include a credit card number, and the like, for payment of the software product(s). As part of the communication with the Licensing Authority, a private/public key pair may be generated using any of a variety of mechanisms. In one embodiment, the public/private key pair is generated by browser software residing on the end-user's computing system. The process continues at block 504, where the end-user submits the license request to the Licensing Authority.

Process proceeds to decision block 506, where the Licensing Authority determines whether the information provided is sufficient and valid for the authentication of the end-user. The Licensing Authority may determine this by an out-of-band process that includes searching another database, repository, and the like. For example, the Licensing Authority may request additional information from the identified employer to authenticate the end-user. The Licensing Authority may further employ the credit and credit card information to authenticate the end-user through a recognized credit card company, bank, financial institution, and the like. In any event, if at decision block 506, the Licensing Authority determines that the license request is valid, including credit card number, and the end-user's authentic, processing branches to block 508; otherwise, processing branches to block 512.

At block 508, the Licensing Authority creates a license, such as the license described above in conjunction with FIG. 4. The license may include the public key provided by the end-user during communications at block 504. The license is digitally signed by the Licensing Authority and includes information that enables the end-user to access the requested software product. A validity period may also be included within the license.

The Licensing Authority provides a notice to the end-user indicating how to access, and install, the license. In one embodiment, the Licensing Authority provides an email to the end-user that includes a Universal Resource Locator (URL) to the license. The email may also include a hash that is based on the public key provided by the end-user. The hash may then be employed to decrypt additional information to access the license. In one embodiment, the license is encrypted using the public key of the end-user, such that only the end-user possessing the associated private key may decrypt and install the license.

Processing continues to 510, where the end-user employs the URL, and hash to obtain the license. The license may be installed in a database, application, folder, and the like on the end-user's computing system. The end-user may now be ready to employ the license to enable access to the desired software product. Upon completion of block 510, the process returns to perform other actions.

Alternatively, if at decision block 506, it is determined that the license request is invalid, the end-user is unauthentic, or the like, the process continues to block 512, where a notice is received by the end-user indicating that the request for the license is rejected. The notice may indicate why the license was rejected, such as “unable to adequately authenticate end-user,” and the like. The notice may also merely indicate that the request has been rejected, without an explanation. In any event, upon completion of block 512, the process returns to perform other actions.

FIG. 6 illustrates a flow chart for one embodiment of a process for employing a software license to enable access to software, in accordance with the present invention. Process 600 may be entered, for example, when an end-user has installed a license employing process 500 described above in conjunction with FIG. 5.

Process 600 begins, after a start block, at decision block 602, where a determination is made whether the desired software is already installed on the end-user's computing system. An end-user may have the software installed prior to requesting a license for the software. The end-user may also seek to obtain the software from another computing system, such as SDS 106 of FIG. 1. In any event, if the software is already installed on the end-user's computing system, processing branches to block 604; otherwise, processing branches to block 610.

At block 610, a request for the software is made. In one embodiment, the request is sent to a software distribution server, such as SDS 106 of FIG. 1. In one embodiment, the request includes the license. In another embodiment, the software distribution server responds with a request for the license. The software distribution server makes a determination whether the license is valid, based in part on, confirmation of the Licensing Authority's digital signature associated with the license, the validity period in the license, the serial number, information associated with the extensions, including but not limited to access rights and constraints associated with the software product, and the like. The software distribution server also requests access to a LRL to determine whether the license is identified in the LRL. If it is determined that the license is valid for the requested software product, the software product is made available for download. In one embodiment, the public encryption key associated with the license is employed to encrypt the software product. Processing continues to block 604

At block 604, if the software was encrypted, the private encryption key associated with the license is employed to decrypt and install the software. The installed software then examines the installed license to determine if the license is valid.

The software may include an Application Programming Interface, subroutine, function, and the like, that is configured to examine the license. Examination may include confirming that the Licensing Authority's digital signature is valid by connecting to a network and requesting confirmation from the License Repository. Examination may further include confirmation that the license has not been revoked, expired, tampered with, and the like. Examination of the license also includes determining whether the license is associated with the software. Such determination may include examining an extension, serial number, public key, and the like, associated with the license to determine whether the license is associated with the software. Examination of the license may further include determining whether the license includes usage restrictions of the software. Usage restrictions may be identified in an extension, encoded within the serial number, and the like.

Processing continues at decision block 606, where if it is determined that the license is valid for the requested use of the software, and has not expired, been revoked, tampered with, or otherwise compromised, processing branches to block 608; otherwise, processing branches to block 612.

At block 608, the software is enabled for execution. The software may employ the digital signature within the license, the serial number, information associated with the extension, and the like, to enable the software for execution. Upon completion of block 608, the process returns for other actions.

Alternatively, at decision block 606, if it is determined that the license is invalid, expired, revoked, or otherwise compromised, processing proceeds to block 612, where the software is disabled from execution. Processing continues to block 614, where a message is provided to the end-user indicating that the license is invalid for this software. In one embodiment, the message is displayed on the end-user's computing monitor. Upon completion of block 614, the process returns to performing other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor provide steps for implementing the actions specified in the flowchart block or blocks.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

We claim:

1. A method for licensing software, comprising:
receiving an electronic request for a license that includes information associated with an end-user and an identifier associated with a software product;
employing the information to authenticate the end-user; and
employing a Licensing Authority to digitally sign the license that enables access to the software product, when the end-user is authentic.

2. The method of claim 1, wherein the Licensing Authority operates substantially similar to a Certification Authority in a Public-Key Infrastructure (PKI).

3. The method of claim 1, wherein receiving the electronic request further comprises, receiving the electronic request from at least one of a web form and an electronic-mail message.

4. The method of claim 1, wherein employing the information to authenticate the end-user further comprises employing at least one of a financial institution, an employer, an educational institution, and a government institution to validate the information.

5. The method of claim 1, wherein the information the end-user further comprises at least one of a name, address, email address, telephone number, credit information, credit card information, employment information, and driver's license.

6. The method of claim 1, further comprising, providing notification on how to access the digitally signed license, wherein the notification comprises at least one of an email message and a webpage.

7. The method of claim 1, wherein the digitally signed license enables access to at least one software product.

8. A method of using a public key infrastructure for licensing software, comprising:
forwarding a request for a license to access a software product to a Licensing Authority, wherein the request comprises information associated with an end-user;
receiving a digitally signed license from the Licensing Authority, when the Licensing Authority determines the end-user is authentic; and
employing the digitally signed license to enable access to the software product.

9. The method of claim 8, wherein the Licensing Authority operates substantially similar to a Certification Authority in a Public-Key Infrastructure (PKI).

10. The method of claim 8, wherein the digitally signed license format is substantially similar to a Public-Key Certificate in an Internet X.509 Public Key Infrastructure (PKI).

11. The method of claim 8, wherein the digitally signed license further comprises an extension field that includes at least one of a Universal Resource Locator (URL), a hash, and software product identifier.

12. The method of claim 11, wherein the digitally signed license further comprises a digital signature associated with the Licensing Authority, wherein the digital signature is created using at least one a Rivest-Shamir-Adleman (RSA) algorithm, Digital Signature Standard (DSS) algorithm, aid a Diffie-Hellman algorithm.

13. The method of claim 8, further comprising receiving a rejection notice from the Licensing Authority, if the Licensing Authority determines the end-user is unauthentic.

14. The method of claim 8, wherein the Licensing Authority determines the end-user is authentic further comprises requesting validation of the information from at least one of a financial institution, an employer, an educational institution, and a government institution.

15. A system for electronic licensing of a software product, comprising:
a client computer configured to provide an electronic request for a license;
a Licensing Authority, coupled to the client computer, that is configured to perform actions, including:
receiving the electronic request for the license that includes information associated with an end-user and an identifier associated with the software product;
employing the information to authenticate the end-user; and
if the end-user is authentic, digitally signing the license, and notifying the client computer where to obtain the digitally signed license, wherein the digitally signed license enables access to the software product.

16. The system of claim 15, further comprising:
a software distribution server, coupled to the client computer, that is configured to perform actions, including:
receiving a request for the software product;
receiving the digitally signed license associated with the software product;
determining if the digitally signed license is valid, and if the digitally signed license is valid, providing access to the software product associated with the valid license.

17. The system of claim 16, wherein determining if the license is valid further comprises examining at least one of the digital signature associated with Licensing Authority, a validity period, a serial number, an extension field, and a license revocation list.

18. The system of claim 16, wherein determining if the license is valid further comprises:
requesting a license revocation list from a Licensing Repository;
determining whether the digitally signed license is identified within the license revocation list; and
denying access to the software product, if the license is identified within the license revocation list.

19. The system of claim 15, wherein the client computer is further configured to perform actions further comprising:
receiving notification of how to obtain the digitally signed license;
installing the digitally signed license; and
employing the digitally signed license to enable access to the software product.

20. The system of claim 15, wherein the Licensing Authority operates. substantially similar to a Certification Authority in a Public-Key Infrastructure (PKI).

21. The system of claim 15, wherein the digitally signed license format is substantially similar to a Public-Key Certificate in an Internet X.509 Public Key Infrastructure (PKI).

22. A system for electronically licensing a software product, comprising:
means for receiving an electronic request for a license that includes information associated with an end-user and an identifier associated with a software product;
means for employing the information to authenticate the end-user; and
means for employing a Licensing Authority to digitally sign the license when the end-user is authentic, wherein the digitally signed license is substantially similar to a Public-Key Certificate in an Internet Public Key Infrastructure (PKI), and wherein the digitally signed license enables access to the software product.
